(19) United States
(12) Patent Application Publication
(10) Pub. No.: US 2003/0214386 A1
(43) Pub. Date: Nov. 20, 2003

(54) Information providing system and information providing method

(75) Inventors: Kazumi Naoi, Kanagawa (JP); Yasushi Kikuchi, Kanagawa (JP); Tohru Futami, Kanagawa (JP)

Correspondence Address: FOLEY AND LARDNER, SUITE 500, 3000 K STREET NW, WASHINGTON, DC, 20007, US

(73) Assignee: NISSAN MOTOR CO., LTD.

(21) Appl. No.: 10/436,161

(22) Filed: May 13, 2003

(30) Foreign Application Priority Data
May 20, 2002 (JP) 2002-144268

(51) Int. Cl. G06F 7/00

(52) U.S. Cl. 340/7.48; 707/3

(57) ABSTRACT

In an information providing system which intermittently provides information which varies along with the passage of time, a plurality of comments which respectively correspond to a plurality of patterns of information change are prepared, and changes of the information which is provided are detected. A comment which corresponds to a change of information which has been detected is searched for among the plurality of comments which are prepared, and the comment which is found is added to the information which is being provided, and the edited information is provided.

### BACKGROUND OF THE INVENTION

1. Field of the Invention

The present invention relates to an information providing system and to an information providing method which provide various types of information for an information terminal.

2. Description of the Related Art

There is a per se known type of information providing system in which road traffic information is transmitted via wireless communication from an information center to an on-vehicle information terminal and is played upon an on-vehicle information terminal, thus being provided to the driver.

### SUMMARY OF THE INVENTION

However, since the usual information which is provided from the information center is intermittent, it is necessary for the driver to store the information which has been previously provided to recognize all the information which has changed over time. For example, when the driver listens to a result of a baseball game which is progressing, he is not able to understand whether the team which he is rooting for is catching up or being caught up, simply by hearing the score at some point of time. Furthermore, for example, if the driver listens to information relating to road congestion, he is not able to understand whether a traffic jam is clearing or whether it is getting worse, simply by hearing the state of a jam at some point of time. In other words, the driver is not able to recognize the flow of the information over time if he does not memorize the information which has been provided previously.

It would be desirable to provide an information providing system and an information providing method which convert information which is intermittent over time into information whose changes over time can easily be appreciated, and which provide this information.

An information providing system according to the present invention which intermittently provides information which varies along with the passage of time comprises a change detection device which detects change of the information, a comment storage device which stores a plurality of comments which respectively correspond to a plurality of information changes, a comment search device which searches among the plurality of comments which are stored in the comment storage device and finds a comment which corresponds to a change of information which has been detected by the change detection device and an editing device which adds the comments which have been found by the comment search device to information which is to be provided, and the information which has been edited by the editing device is provided.

An information providing method according to the present invention which intermittently provides information which varies along with the passage of time comprises generating a plurality of comments which respectively correspond to a plurality of information changes, detecting change of the information which is provided, searching among the plurality of comments which are generated and finding a comment which corresponds to a change of information which has been detected, adding the comments which have been found to information which is to be provided and providing the edited information.

### BRIEF DESCRIPTION OF THE DRAWINGS

FIG. 1 shows the overall structure of an information providing system according to the preferred embodiment of the present invention.

FIG. 2 presents an example of a comment table for a baseball game.

FIG. 3 presents certain details of the comment table for a baseball game.

FIG. 4 shows a baseball game comments for image presentation and game comments for speech presentation.

FIG. 5 continues on from FIG. 3, showing details of the comment table for a baseball game.

FIG. 6 continues on from FIG. 4, showing a baseball game comments for image presentation and game comments for speech presentation.

FIG. 7A is a flowchart showing the progress of a procedure which is performed by an on-vehicle information terminal, and FIG. 7B is a flowchart showing the progress of a procedure which is performed by an information center.

### DETAILED DESCRIPTION OF THE PREFERRED EMBODIMENT

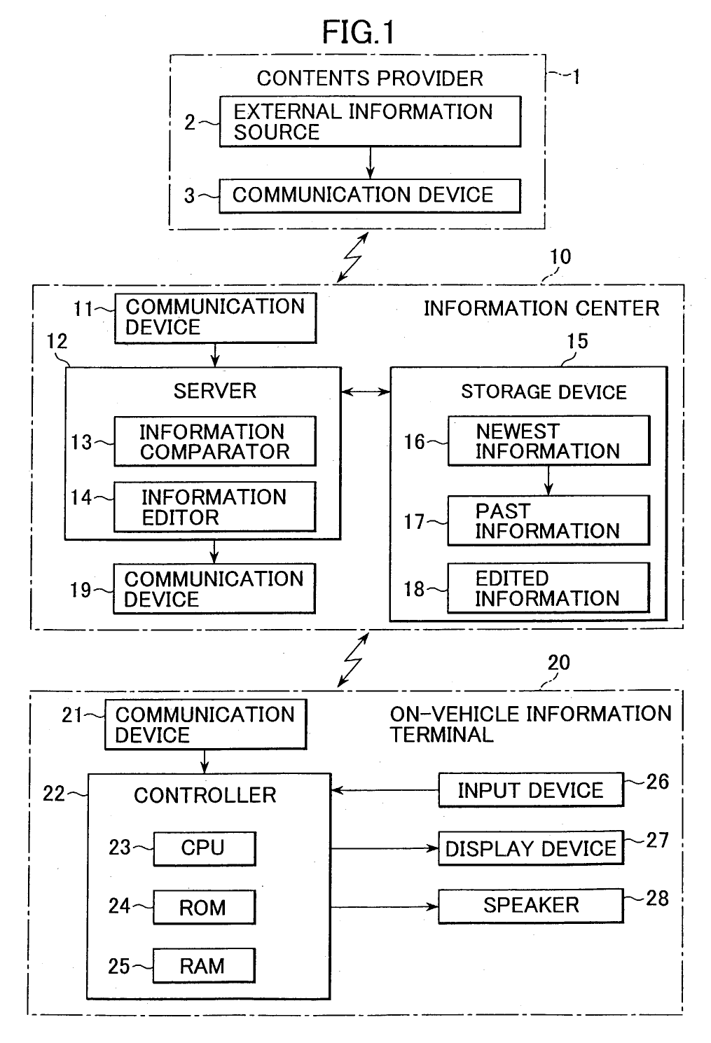

A preferred embodiment of the on-vehicle information providing system according to the present invention will now be explained in terms of its application to the transmission of various types of information from an information center to an on-vehicle information terminal. FIG. 1 shows the overall structure of this information providing system according to the preferred embodiment. This preferred embodiment of the information providing system comprises a contents provider 1 which is an information source, an information center 10 which edits and provides information and an on-vehicle information terminal 20 which presents information which has been provided from the information center 10 to the driver of a vehicle in which this terminal 20 is installed.

It is to be noted that, although only one on-vehicle information terminal 20 is shown in FIG. 1, it is supposed that in fact a large number of such on-vehicle information terminals will be operating at the same time in cooperation with the single information center 10. Furthermore, a plurality of contents providers 1 and information centers 10 may also be present.

The contents provider 1 receives various types of information from external information sources 2 and transmits them to the information center 10 via a communication device 3.

The information center 10 comprises a communication device 11, a server 12, a storage device 15 and a communication device 19. The information which has been provided from the contents provider 1 is received by the information center 10 via the communication device 11. The server 12 stores the information which has thus been received from the contents provider 1 in the storage device 15.

The storage device 15 comprises a newest information storage region 16 for storing the newest information, a past information storage region 17 for storing past information and an edit information storage region 18 for storing a comment table which will be described hereinafter. Along with the newest information which has been received from the contents provider 1 being stored in the newest information storage region 16, the past information, which until this time point has been stored in the newest information storage region 16, is shifted to the past information storage region 17.

The server 12 comprises an information comparison section 13 and an information edit section 14 which are implemented in the form of software upon a computer. The information comparison section 13 and an information edit section 14 perform processing for providing information of which the change is to be easily understood. The information comparison section 13 compares together and examines the newest information which is stored in the newest information storage region 16 and the past information which is stored in its past information storage region 17, and thereby detects changes which have taken place in this information. The information edit section 14 searches out comments which correspond to the changes of information from the comment table which is stored in the edit information storage region 18 in the storage device 15, and edits information by adding the comments which have been found to the newest information. The server 12 transmits the information to which the comments corresponding to the changes of information have been added to the on-vehicle information terminal 20 via the communication device 19.

The on-vehicle information terminal 20 comprises a communication device 21, a controller 22, an input device 26, a display device 27, a speaker 28 and the like. The controller 22 comprises a CPU 23, a ROM 24, a RAM 25 and the like, and, along with transmitting information providing requests which the driver of the vehicle has inputted with the input device 26 to the information center 10 via the communication device 21, receives information which is to be provided from the information center 10 via the communication device 21. This information to be provided is displayed on the display device 27 and is output by the speaker 28.

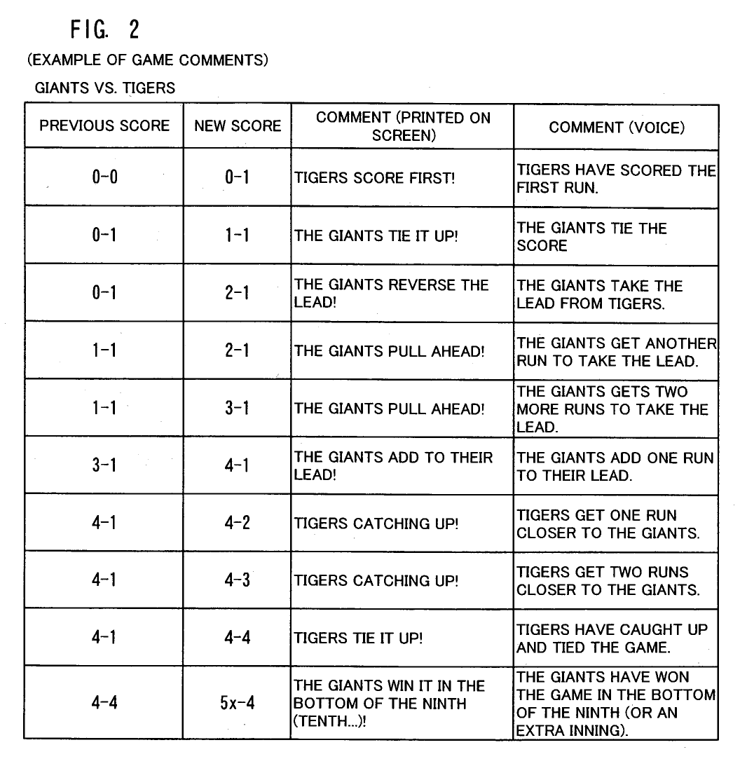

In the following, using FIGS. 2 through 6, an example will be explained in which information regarding the ongoing state of a baseball game is transmitted to the on-vehicle information terminal 20. This information which is transmitted to the on-vehicle information terminal 20 contains both image contents which are to be provided as image data in character form, and speech contents which are encoded as character data and which are to be provided by being voiced through the speaker 28.

FIG. 2 is a figure showing an example of a comment table which is utilized for providing such information relating to a baseball game. The information regarding the ongoing state of a baseball game is typically provided intermittently, rather than being provided continuously as a relay from the spot. Accordingly the driver cannot know whether the team for which he is rooting is catching up, or is falling back, only by hearing the ongoing situation at some time point. Thus, in this preferred embodiment of the present invention, the score situation for the previous inning and the score situation for the present inning are compared together, and a game comment is generated if there has been any change in the score situation.

The game comment varies according to the type of change of the score situation and according to the team whose score has changed. Furthermore, a game comment which is to be provided as an image in character form and a game comment which is to be provided as a spoken message are prepared in advance.

In FIG. 2, in a game between the Giants and the Tigers, there is shown an example of the past information about the score situation in the previous inning, and the newest information about the score situation in the present inning. Here, for example, when in a score situation between the Giants and the Tigers of 0-1 the Giants have scored 1, if only a so called fragmentary type presentation of ongoing information were to be provided such as “The score situation between the Giants and the Tigers is 1-1”, listeners (drivers) could not understand whether the Giants had caught up with the Tigers or had been caught up.

In this case, the score situation in the previous inning of 0-1 and the score situation in the present inning of 1-1 are compared together, and thus it is possible to decide that the Giants have tied the score. Here, in addition to the ongoing information “The score situation between the Giants and the Tigers is 1-1”, the comment in character form “Giants tied it up!!” is displayed upon the display screen and the speech comment “The Giants have tied the score!” is broadcast from the speaker 28.

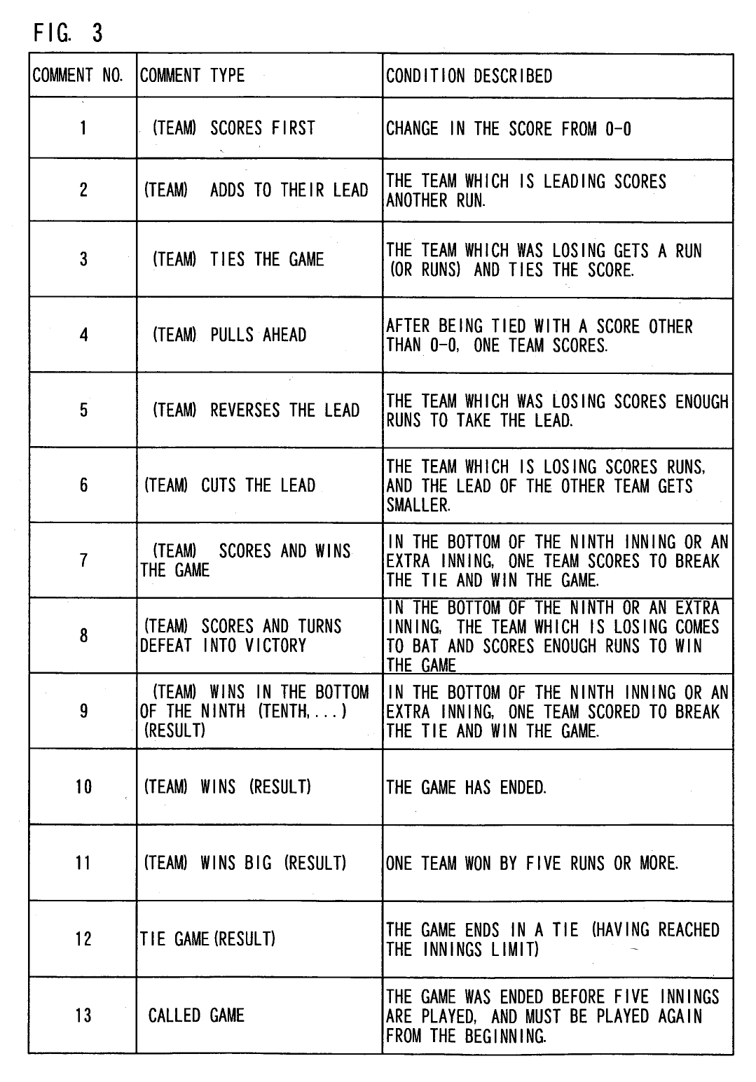

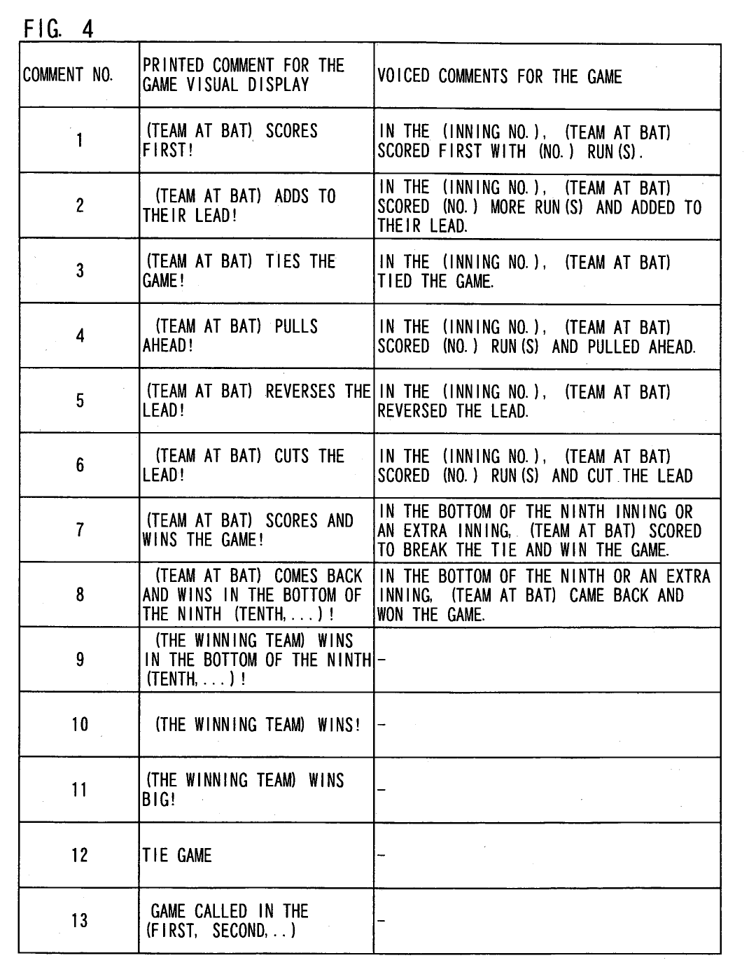

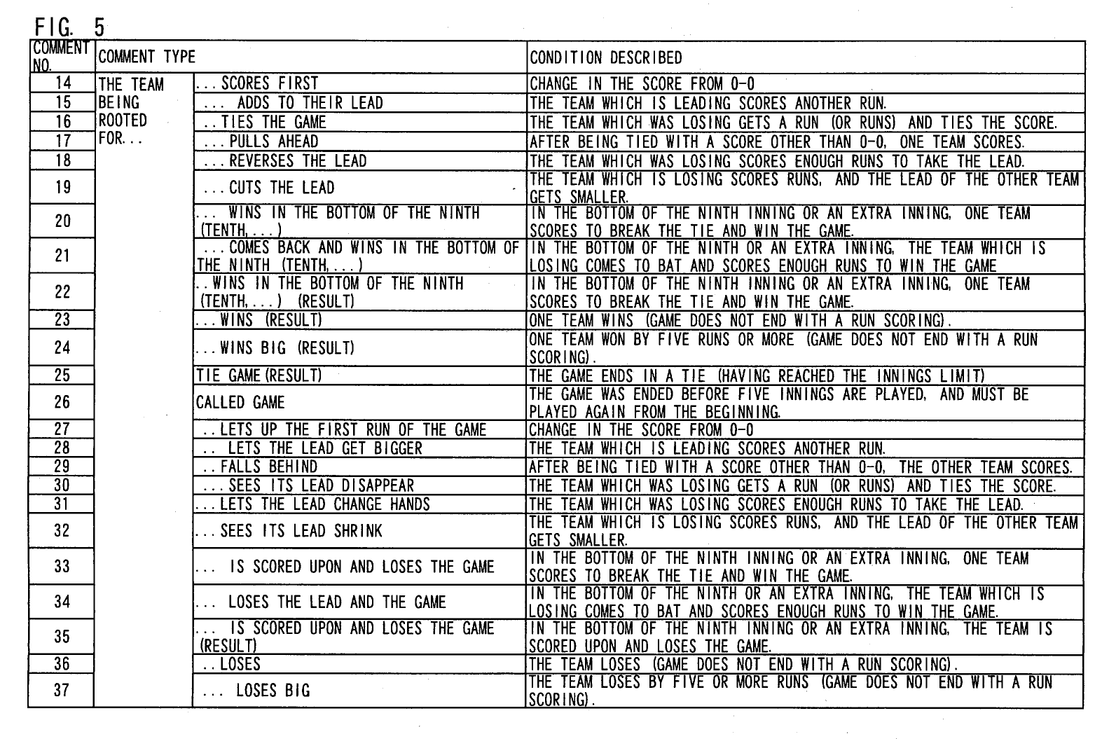

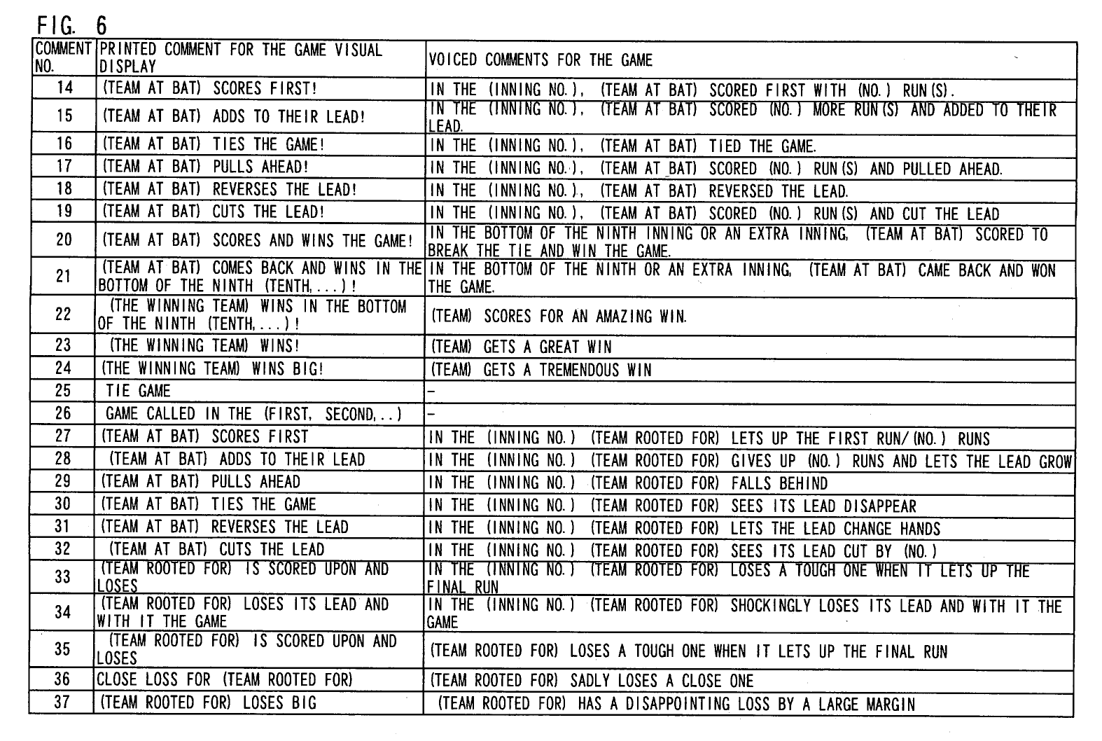

FIGS. 3 through 6 are figures showing the details of a comment table for providing information about a baseball game. FIG. 3 shows types of comments and their conditions of applicability which have IDs 1 through 13, and FIG. 4 shows game comments for image presentation and game comments for speech presentation for these IDs 1 through 13. FIG. 5 shows types of comments and their conditions of applicability which have IDs 14 through 37, while FIG. 6 shows game comments for image presentation and game comments for speech presentation for these IDs 14 through 37. The comments which have IDs 1 through 13 are game comments which are applicable for all teams, while the comments which have IDs 14 through 37 are game comments which are applicable for the team for which the driver is rooting for.

For example, if the team which the driver is not rooting for scores a come-from-behind victory, then according to the conditions of applicability “in the bottom of the ninth or an extra inning, the losing team comes to bat and scores enough runs to win the game”, the comment with ID8 “scores and turns defeat into victory” is selected. Accordingly, along with displaying the character comment “(team at bat) comes back and wins in the bottom of (inning)” of the comment ID8 upon the screen, the speech comment “in the bottom of (inning), (team) came back and won the game” is played through the speaker 28. It is to be noted that the name of the team which scores and turns defeat into victory is inserted into the field (team at bat), while the number of the innings in which the losing team has scored is inserted into the field (inning). On the other hand, if it is the team for which the driver is rooting, then the name of the team for which he is rooting is inserted into these fields of the comments.

In the above described example of the ongoing information relating to a baseball game, when a change occurs in the ongoing information, the comment whose conditions of applicability match this change of information is selected from the comment table shown in FIGS. 3 through 6, and comments are appended to the portion of the comment shown in FIGS. 3 through 6 which is surrounded by parentheses, such as (team), (inning No.), (score No.) and (team rooted for) or the like.

In the above described comment table for the ongoing information for a baseball game, by way of example, it has been shown that the comments which correspond to ordinary teams and the comments which correspond to the team for which the driver is rooting are prepared, and the former comments are selected if the team in question is not the team for which the driver is rooting, while the latter comments are selected if the team in question is the team for which the driver is rooting. In this manner, by dividing the comments into several groups according to a discriminatory characteristic of the person who is requesting the information, such as, for example, sex, age, occupation, personal preference or the like, and by selecting a comment corresponding to the change of information from those comment groups which correspond to the discriminatory characteristic of the person who is requesting the information to be provided, it is possible to append to the information the most suitable comment from the point of view of the person who is requesting the information to be provided.

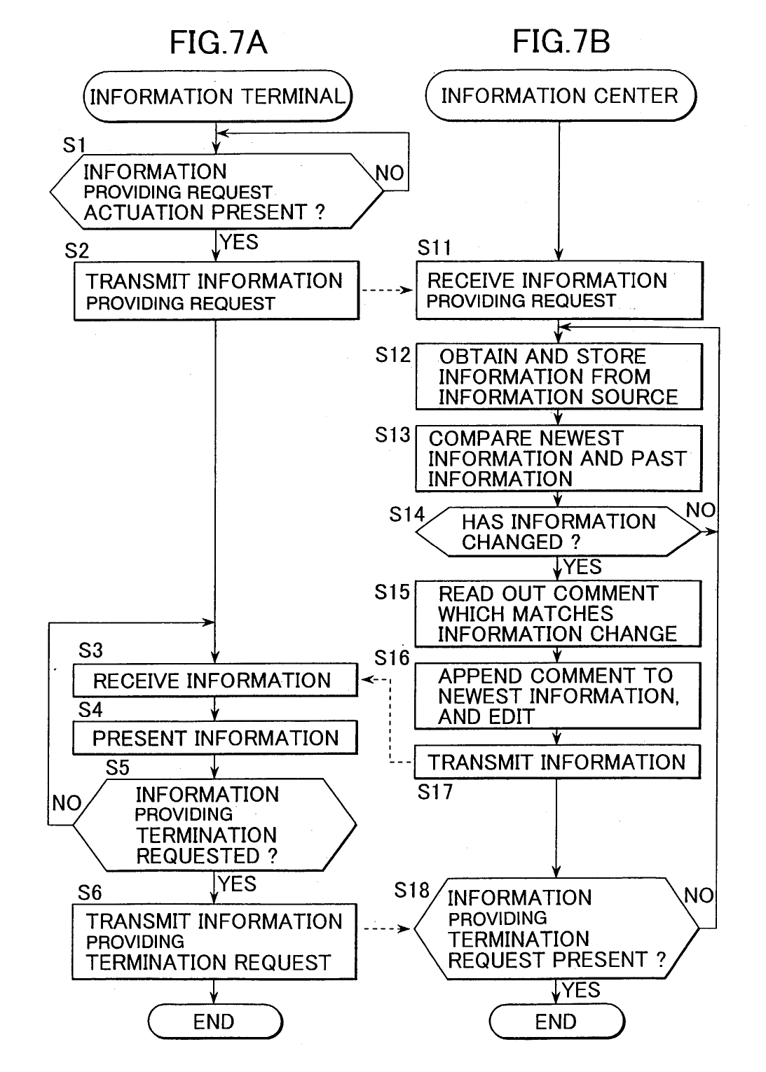

FIGS. 7A and 7B are flowcharts showing, for this preferred embodiment of the present invention, the procedures for providing the information which the information center 10 has prepared to the on-vehicle information terminal 20 which requests information providing. The program shown in FIG. 7A is executed by the controller 22 in the on-vehicle information terminal 20, while the program shown in FIG. 7B is executed by the server 12 in the information center 10.

In the step S1, the on-vehicle information terminal 20 makes a decision as to whether or not an information providing request actuation by the driver is present. Such an information providing request actuation occurs when the driver actuates the input device 26 to display the information providing menu screen upon the display device 27, and inputs the type or details of the information which he desires to be provided. If it is judged that such an information providing request actuation is present, the flow of control proceeds to the next step S2. In the step S2, the information providing request is transmitted to the information center 10, along with the providing conditions such as the type and details of the information input by the driver.

In the step S11, the information center 10 receives this information providing request from the on-vehicle information terminal 20. In the step S12 following the step S11, an information source, in other words a contents provider, is selected according to the providing conditions such as the type and details and the like of the information, and the information which has been requested by the on-vehicle information terminal 20 is obtained. This information which has been obtained is stored in the newest information storage region 16 in the storage device 15 and the previous version of the same type of information which up until now has been currently stored in the newest information storage region 16 is shifted to the past information storage region 17.

In the step S13 following the step S12, the information comparison section 13 in the information center 10 compares together the newest information which is now stored in the newest information storage region 16 and the past information which is now stored in the past information storage region 17. When the newest information and the past information have been compared together, the flow of control proceeds to the step S14. In the step S14, a decision is made as to whether or not the newest information has changed from the past information. If it is decided that there are no changes present in the information, then the flow of control returns to the step S12 and the obtaining of the information from the information source is repeated. On the other hand, if it is decided that the information has in fact changed, then the flow of control proceeds to the next step S15.

In the step S15, a comment whose change match the conditions of applicability is read out in the comment table which is stored in the edit information storage region 18 in the storage device 15. In the comment table, various patterns of change are hypothesized in advance for this information according to the type and the details of the information, and the most suitable comments are prepared according to the various patterns of change. In other words, the comment table is built up by arranging the comments for use for image display and the comments for use as speech based upon type of comment and conditions of applicability. This comment table which has been thus built up is stored in the edit information storage region 18 in the storage device 15.

In the step S16 following the step S15, the information edit section 14 in the information center 10 performs editing of the information for providing it to the on-vehicle information terminal 20. In other words, the comments which have been read out from the edit information storage region 18 and which correspond to the changes of information are appended to the newest information which is stored in the newest information storage region 16 in the storage device 15. When the editing of the information has been completed, the flow of control proceeds to the next step S17. In the step S17, the edited information is provided to the on-vehicle information terminal 20.

In the step S3, the on-vehicle information terminal 20 receives from the information center 20 the information to which the comment has been added. In the next step S4 which follows the step S3, the image contents which are included in the information which has been received are displayed upon the display device 27 and the speech contents are played through the speaker 28. Accordingly, characters which have been added as a screen display comment corresponding to the change of information are displayed upon the display device 27, while commentary which has been added as a speech comment corresponding to the change of information is played through the speaker 28. When the information which has been received has been provided to the driver, the flow of control proceeds to the step S5.

In the step S5, the on-vehicle information terminal 20 makes a decision as to whether or not an information providing termination actuation has been performed via the input device 26. If it is decided that such an information providing termination actuation has not been performed, then the flow of control returns to the step S3 and the process of information reception from the information center 10 is continued. On the other hand, if it is decided that an information providing termination actuation has been performed by the vehicle driver, then the flow of control proceeds to the next step S6. In this step S6, an information providing termination request is transmitted to the information center 10.

In the step S18, the information center 10 makes a decision as to whether or not the information center 10 has received an information termination request. If it is decided that an information providing termination request has not received, then the flow of control returns to the step S12 and the above described process of information providing is repeated. On the other hand, if it is decided that an information providing termination request has received, then the providing information is terminated and this procedure terminates.

If the information which changes along with the passage of time is provided intermittently, the information providing system according to this preferred embodiment of the present invention detects change of this information, searches out the comment which corresponds to this change of information from a comment table in which comments are established which are respectively suitable for a plurality of patterns of information change, edits the information by adding the comment which has been found to the newest version of the information, and provides the final version of the edited information. Accordingly, even if information which changes along with the passage of time is being provided intermittently, it is possible to provide information whose changes can be understood.

The above described embodiment is an example, and various modifications can be made without departing from the spirit and scope of the invention. For example, in the above described preferred embodiment, the comments which corresponded to the change of information were added to the information in the information center 10 and the edited version of the information was provided to the information terminal; but this is only by way of example, and the information terminal may edit the information which is provided intermittently. Namely, the information terminal may add the comments which corresponded to the change of information to the information and provides the edited information to the user of the information terminal.

Furthermore, the information which is provided is not to be considered as being limited to ongoing information about a baseball game as was described by way of example above; it is possible to apply the present invention to the presentation of any desired type of information. When applying the present invention to any desired type of information which varies along with the passage of time, it is necessary to consider in advance various patterns of change for this information which is to be the object of application according to the type and the details thereof, and to prepare the most suitable possible comments for each of these patterns of change. A comment table like the one shown in FIGS. 3 through 6 should be made by arranging these comments which are to be utilized for screen presentation or for speech presentation according to the types of the comments and their conditions of application, and then this comment table should be stored in the edit information storage region 18 in the storage device 15.

Furthermore, the terminal for presenting the information is not to be considered as being limited to an on-vehicle information terminal; it would be possible to apply the present invention to any type of information terminal, such as a portable information terminal or the like.

The disclosure of the following priority application is herein incorporated by reference: Japanese Patent Application No. 2002-144268, filed May 20, 2002.

What is claimed is:

1. An information providing system which intermittently provides information which varies along with the passage of time, comprising:
a change detection device which detects change of the information;
a comment storage device which stores a plurality of comments which respectively correspond to a plurality of information changes;
a comment search device which searches among the plurality of comments which are stored in the comment storage device and finds a comment which corresponds to a change of information which has been detected by the change detection device; and
an editing device which adds the comments which have been found by the comment search device to information which is to be provided, wherein:
the information which has been edited by the editing device is provided.

2. An information providing system according to claim 1, wherein:
the change detection device detects change of information by comparing new information with information from the past.

3. An information providing system according to claim 1, wherein:
the plurality of comments which are stored in the comment storage device are stored in a comment table, and the comment storage device stores a plurality of comment tables in correspondence to the type and the details of information.

4. An information providing system according to claim 1, wherein:
the plurality of comments which are stored in the comment storage device are stored in a comment table, and the comment storage device stores a plurality of comment tables in correspondence to a discriminatory characteristic for the person who requests information.

5. An information providing system according to claim 4, wherein:
the discriminatory characteristic for the person who requests information includes at least one of sex, age, occupation and personal preference.

6. An information providing system according to claim 1, wherein:
the plurality of comments which are stored in the comment storage device are stored in a comment table, and the comment storage device stores a comment table for image content and a comment table for sound content.

7. An information providing system according to claim 1, wherein:
the information is provided from an information center to an on-vehicle information terminal via wireless communication, and the change detection device, the comment storage device and the comment search device are provided in the information center.

8. An information providing system which intermittently presents information which varies along with the passage of time, comprising:
a change detection means for detecting change of the information;
a comment storage means for storing a plurality of comments which respectively correspond to a plurality of information changes;
a comment search means for searching among the plurality of comments which are stored in the comment storage means and finds a comment which corresponds to a change of information which has been detected by the change detection means; and
an editing means for adding the comments which have been found by the comment search means to information which is to be provided, wherein:
the information which has been edited by the editing means is provided.

9. An information providing method which intermittently provides information which varies along with the passage of time, comprising:
generating a plurality of comments which respectively correspond to a plurality of information changes;
detecting change of the information which is to be provided;
searching among the plurality of comments which are generated and finding a comment which corresponds to a change of information which has been detected;
editing information by adding the comments which have been found to information which is to be provided; and
providing the edited information.
